(19) United States
(12) Patent Application Publication
(10) Pub. No.: US 2007/0151555 A1
(43) Pub. Date: Jul. 5, 2007

(54) Tile pliers saving the manual work

(76) Inventor: Cheng-Tsung Hung, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/324,109

(22) Filed: Jan. 3, 2006

(51) Int. Cl. B28D 1/32

(52) U.S. Cl. 125/23.01

(57) ABSTRACT

A pair of tile pliers includes two handles each having a first end provided with a clamping portion and a second end provided with a grip portion. The clamping portion of each of the handles has a side formed with a tapered clamping face having a narrower first side and a wider second side. Thus, the narrower first side of the clamping face produces a stress concentration on the porcelain tile to break the surface structure of the porcelain tile so that the edge of the porcelain tile is cut in a easier manner to save the manual work. In addition, the clamping face has a tapered shape so that the clamping face presses and clamps the porcelain tile gradually so as to cut the porcelain tile smoothly and linearly.

### BACKGROUND OF THE INVENTION

1. Field of the Invention

The present invention relates to a pair of tile pliers and, more particularly, to a pair of tile pliers for shearing or cutting porcelain tiles.

2. Description of the Related Art

A pair of conventional tile pliers in accordance with the prior art shown in FIGS. 4 and 5 comprise two handles 10 pivotally connected with each other by a pivot shaft 12 and each having a first end provided with a clamping portion 13 and a second end provided with a grip portion 11. The clamping portion 13 of each of the two handles 10 has a side formed with a flat clamping face 14. The clamping faces 14 of the two handles 10 are parallel with each other to clamp a porcelain tile (not shown). When in use, the clamping faces 14 of the two handles 10 are clamped on the porcelain tile to break the surface structure of the porcelain tile so that the edge of the porcelain tile is cut in a flat manner. However, the clamping face 14 of each of the two handles 10 entirely contact the porcelain tile to increase its contact area with the porcelain tile so that the user has to exert a larger force to break the surface structure of the porcelain tile, thereby wasting the manual work.

Another pair of conventional tile pliers in accordance with the prior art shown in FIGS. 6 and 7 comprise two handles 15 pivotally connected with each other by a pivot shaft 17 and each having a first end provided with a clamping portion 18 and a second end provided with a grip portion 16. The clamping portion 18 of each of the two handles 15 has a side formed with an arc-shaped clamping face 19. The clamping faces 19 of the two handles 15 face each other to clamp a porcelain tile (not shown). When in use, the clamping faces 19 of the two handles 15 are clamped on the porcelain tile to break the surface structure of the porcelain tile so that the edge of the porcelain tile is cut in a easier manner by the arc-shaped design of the clamping face 19. However, the clamping face 19 of each of the two handles 15 is partially in contact with the porcelain tile, so that the edge of the porcelain tile is cut in an irregular manner, thereby decreasing the aesthetic quality of the cut porcelain tile.

### SUMMARY OF THE INVENTION

In accordance with the present invention, there is provided a pair of tile pliers, comprising two handles pivotally connected with each other and each having a first end provided with a clamping portion and a second end provided with a grip portion. The clamping portion of each of the two handles has a side formed with a tapered clamping face.

The primary objective of the present invention is to provide a pair of tile pliers that are operated in a easier manner to save the manual work.

Another objective of the present invention is to provide a pair of tile pliers, wherein the narrower first side of the clamping face of each of the two handles produces a stress concentration on the respective face of the porcelain tile to break the surface structure of the porcelain tile so that the edge of the porcelain tile is cut in a easier manner to save a manual work.

A further objective of the present invention is to provide a pair of tile pliers, wherein the first side of the clamping face of each of the two handles has reduced thickness to decrease its contact area with the porcelain tile so that the edge of the porcelain tile is broken easily and conveniently, thereby saving the manual work.

A further objective of the present invention is to provide a pair of tile pliers, wherein the clamping face of each of the two handles has a tapered shape so that the clamping face of each of the two handles presses and clamps the porcelain tile gradually so as to cut the porcelain tile smoothly and linearly.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a pair of tile pliers in accordance with the preferred embodiment of the present invention.

FIG. 2 is a locally plan enlarged view of the tile pliers as shown in FIG. 1.

FIG. 3 is a schematic operational view of the tile pliers as shown in FIG. 1 in use.

FIG. 4 is a perspective view of conventional tile pliers in accordance with the prior art.

FIG. 5 is a locally plan enlarged view of the conventional tile pliers as shown in FIG. 4.

FIG. 6 is a perspective view of another conventional tile pliers in accordance with the prior art.

FIG. 7 is a locally plan enlarged view of the conventional tile pliers as shown in FIG. 6.

### DETAILED DESCRIPTION OF THE INVENTION

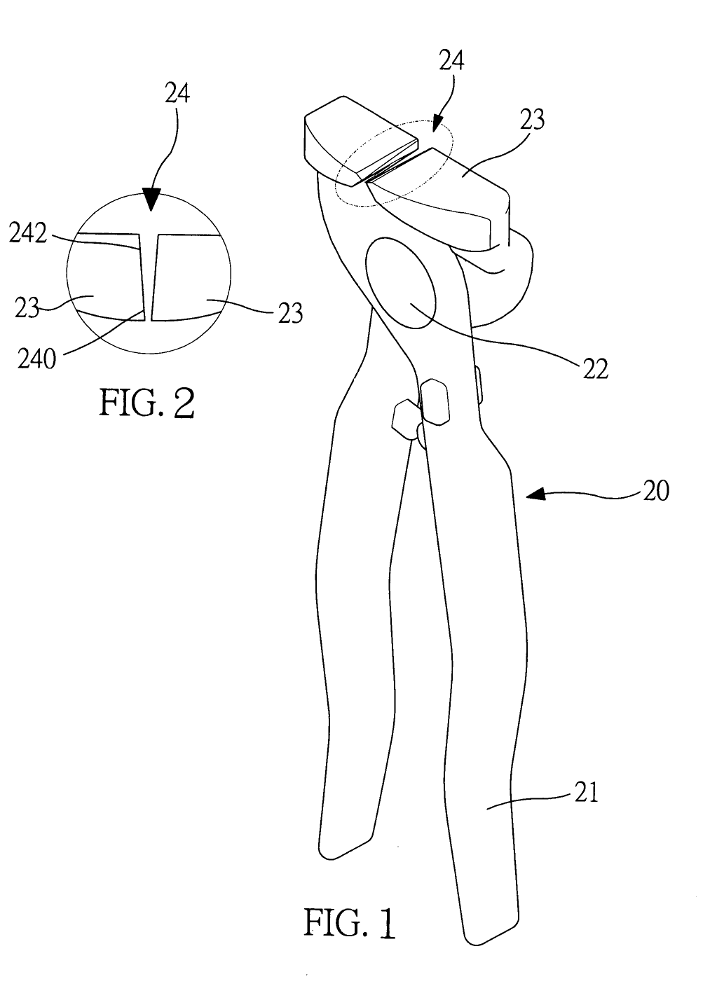

Referring to the drawings and initially to FIGS. 1 and 2, a pair of tile pliers in accordance with the preferred embodiment of the present invention comprises two handles 20 pivotally connected with each other by a pivot shaft 22 and each having a first end provided with a clamping portion 23 and a second end provided with a grip portion 21.

The clamping portion 23 of each of the two handles 20 has a side formed with a tapered clamping face 24, and the clamping faces 24 of the two handles 20 face each other. The clamping face 24 of each of the two handles 20 has a flat and smooth structure. The clamping face 24 of each of the two handles 20 has a first side 240 and a second side 242, wherein the clamping face 24 of each of the two handles 20 has a width reduced gradually from the first side 240 to the second side 242. Thus, the distance between the first sides 240 of the clamping faces 24 is smaller than that of the second sides 242 of the clamping faces 24, so that the clamping faces 24 of the two handles 20 form a substantially horn shaped profile and have relatively narrower first sides 240 and relatively wider second sides 242 as shown in FIG. 2. In addition, the first side 240 of the clamping face 24 of each of the two handles 20 has a reduced thickness and has a sharp edge. In addition, the clamping faces 24 of the two handles 20 are not parallel with each other.

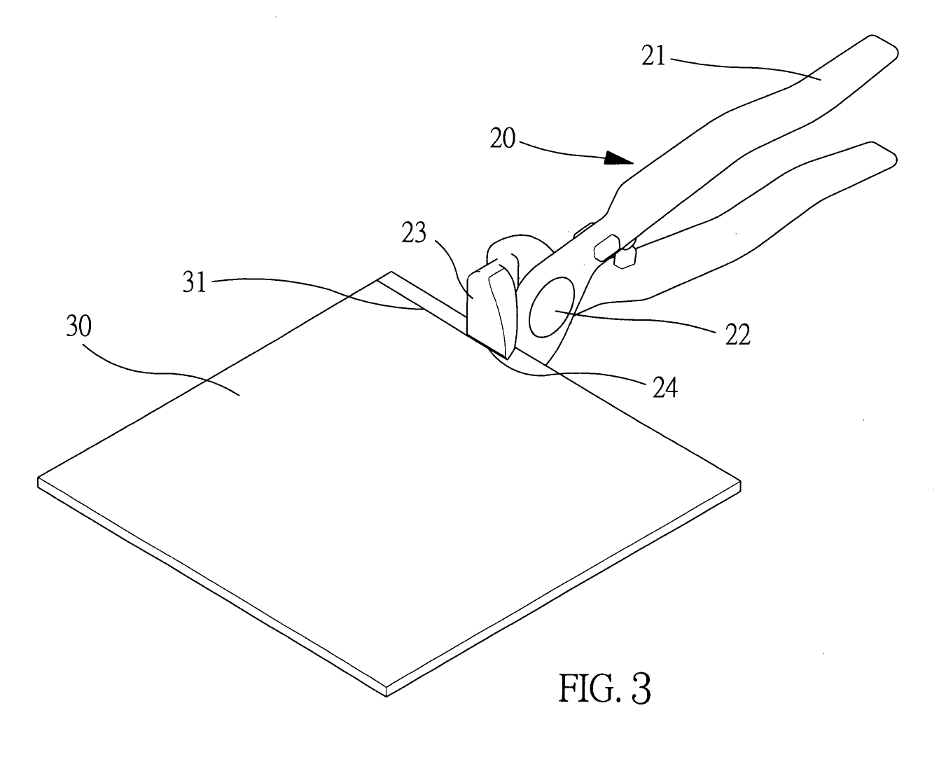

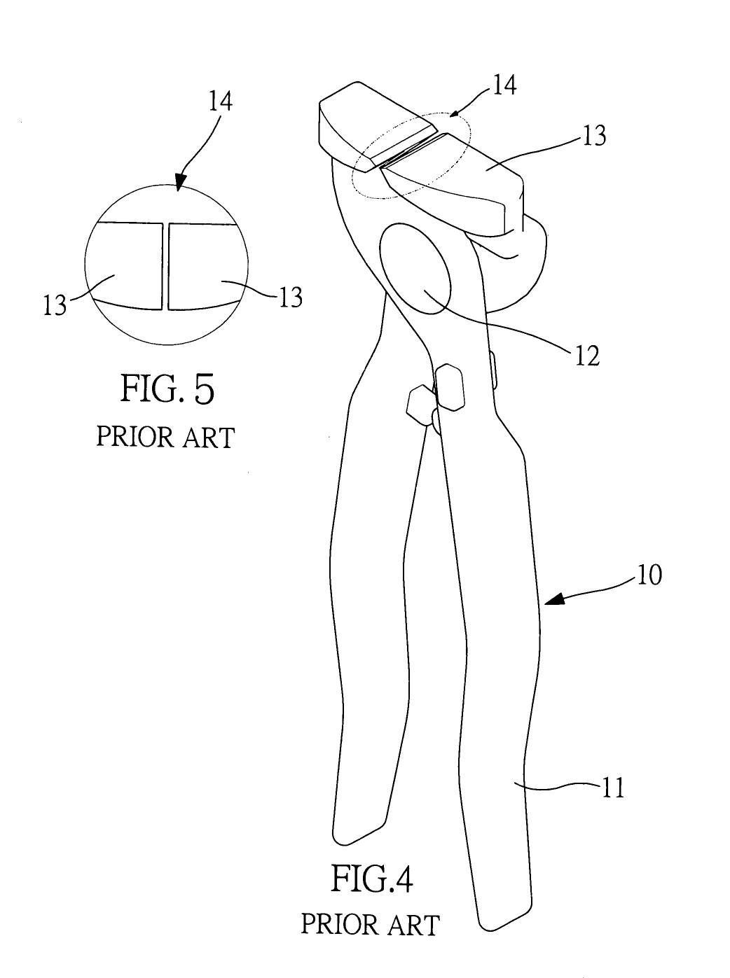

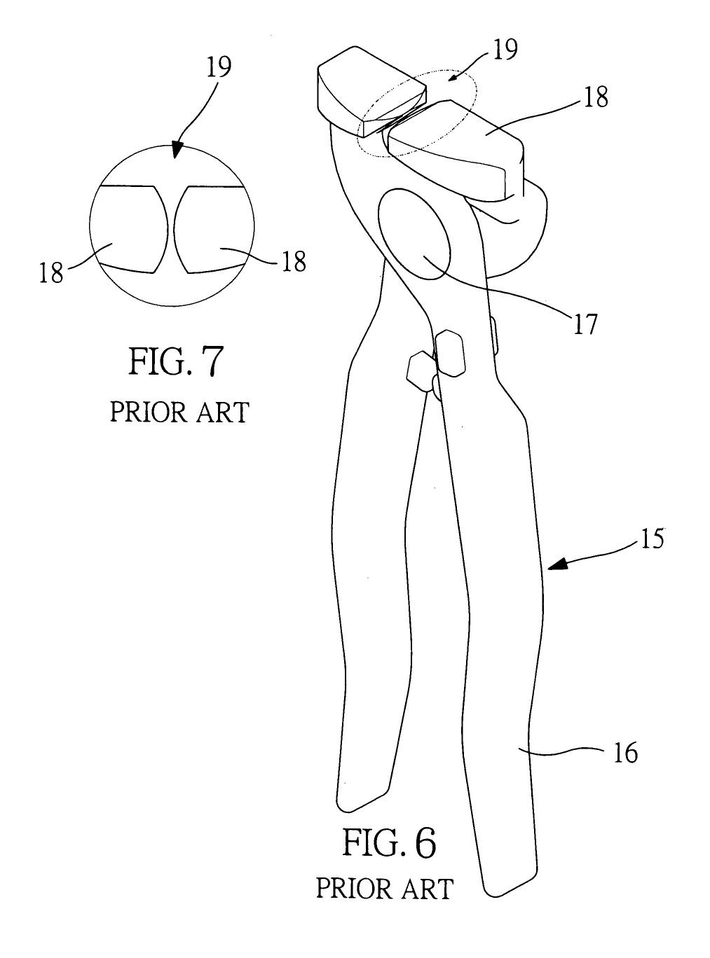

As shown in FIGS. 2 and 3, when the clamping faces 24 of the two handles 20 are rested on a porcelain tile 30, the first side 240 of the clamping face 24 of each of the two handles 20 is rested on a respective face of the porcelain tile 30, so that when the clamping faces 24 of the two handles 20 apply a force on the porcelain tile 30, the first side 240 of the clamping face 24 of each of the two handles 20 produces a stress concentration on the respective face of the porcelain tile 30 to break the surface structure of the porcelain tile 30 in a flat and smooth manner. In addition, the clamping face 24 of each of the two handles 20 has a-tapered shape so that the clamping face 24, of each of the two handles 20 presses and clamps the porcelain tile 30 gradually so as to cut the porcelain tile 30 like scissors. Thus, the clamping faces 24 of the two handles 20 are movable on the porcelain tile 30 to form a flat and smooth line 31 on the surface of the porcelain tile 30, so that the edge of the porcelain tile 30 is bent and broken in a flat and smooth manner so as to trim the edge of the porcelain tile 30 smoothly.

Accordingly, the narrower first side 240 of the clamping face 24 of each of the two handles 20 produces a stress concentration on the respective face of the porcelain tile 30 to break the surface structure of the porcelain tile 30 so that the edge of the porcelain tile 30 is cut in a easier manner to save a manual work. In addition, the first side 240 of the clamping face 24 of each of the two handles 20 has reduced thickness to decrease its contact area with the porcelain tile 30 so that the edge of the porcelain tile 30 is broken easily and conveniently, thereby saving the manual work. Further, the clamping face 24 of each of the two handles 20 has a tapered shape so that the clamping face 24 of each of the two handles 20 presses and clamps the porcelain tile 30 gradually so as to cut the porcelain tile 30 smoothly and linearly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A pair of tile pliers, comprising two handles pivotally connected with each other and each having a first end provided with a clamping portion and a second end provided with a grip portion, wherein:
the clamping portion of each of the two handles has a side formed with a tapered clamping face.

2. The tile pliers in accordance with claim 1, wherein the clamping face of each of the two handles has a first side and a second side, wherein a distance between the first sides of the clamping faces is smaller than that of the second sides of the clamping faces.

3. The tile pliers in accordance with claim 2, wherein the clamping face of each of the two handles has a width reduced gradually from the first side to the second side.

4. The tile pliers in accordance with claim 2, wherein the clamping faces of the two handles form a substantially horn shaped profile and have relatively narrower first sides and relatively wider second sides.

5. The tile pliers in accordance with claim 2, wherein the first side of the clamping face of each of the two handles has a reduced thickness.

6. The tile pliers in accordance with claim 2, wherein the first side of the clamping face of each of the two handles has a sharp edge.

7. The tile pliers in accordance with claim 1, wherein the clamping faces of the two handles are not parallel with each other.

8. The tile pliers in accordance with claim 2, wherein when the clamping faces of the two handles are rested on a porcelain tile, the first side of the clamping face of each of the two handles is rested on a respective face of the porcelain tile, so that when the clamping faces of the two handles apply a force on the porcelain tile, the first side of the clamping face of each of the two handles produce a stress concentration on the respective face of the porcelain tile to break a surface structure of the porcelain tile in a easier manner to save a manual work.

9. The tile pliers in accordance with claim 8, wherein the clamping face of each of the two handles has a tapered shape so that the clamping face of each of the two handles presses and clamps the porcelain tile gradually so as to cut the porcelain tile like scissors.

10. The tile pliers in accordance with claim 9, wherein the clamping faces of the two handles are movable on the porcelain tile to form a flat and smooth line on the surface of the porcelain tile, so that the edge of the porcelain tile is bent and broken in a flat and smooth manner so as to trim the edge of the porcelain tile smoothly.

11. The tile pliers in accordance with claim 1, wherein the clamping faces of the two handles face each other.

12. The tile pliers in accordance with claim 1, wherein the clamping face of each of the two handles has a flat and smooth structure.
